(19) United States
(12) Patent Application Publication
(10) Pub. No.: US 2025/0153974 A1
(43) Pub. Date: May 15, 2025

(54) BRAKE CATCHING DEVICE

(71) Applicant: Cobianchi Liftteile AG, Oberdiessbach (CH)

(72) Inventors: Martial GRAF, Köniz (CH); Rudolf RAMSEIER, Teuffenthal (CH)

(73) Assignee: Cobianchi Liftteile AG, Oberdiessbach (CH)

(21) Appl. No.: 18/835,454

(22) PCT Filed: Feb. 2, 2023
(86) PCT No.: PCT/EP2023/052561

§ 371 Date: Aug. 2, 2024

(30) Foreign Application Priority Data
Feb. 4, 2022 (AT) A50059/2022
Dec. 13, 2022 (EP) 22213209.4

(51) Int. Cl. B66B 5/20

(52) U.S. Cl. CPC B66B 5/20

(57) ABSTRACT

In a safety brake device for a conveying device, a brake shoe is designed to engage at a rail arranged parallel to the conveying route in a stationary manner when the device is triggered. An engagement lever on the rail side opposite the shoe is pivotable between a release position and at least one brake position. In the brake position, the rail is clamped between the end of the engagement element and the shoe. The engagement element is pivotable using a trigger lever, so that, in each brake position of the trigger lever, the engagement element is also in a brake position. The trigger element is mounted to be displaceable along or parallel to its longitudinal axis and has a first end position in the vicinity of the rail and another end position at a distance from the rail. An electrically controllable actuation arrangement prevents or causes this displacement.

### CROSS REFERENCE TO RELATED APPLICATIONS

This application is the National Stage of PCT/EP2023/052561 filed on Feb. 2, 2023, which claims priority under 35 U.S.C. § 119 of European Application No. 22213209.4 filed on Dec. 13, 2022 and Austrian Application No. A50059/2022 filed Feb. 4, 2022, the disclosures of which are incorporated by reference. The international application under PCT article 21 (2) was not published in English.

### BACKGROUND OF THE INVENTION

### 1. Field of the Invention

The invention relates to a safety brake device for a conveying means, in particular for an elevator cabin and/or for a counterweight.

### 2. Description of the Related Arts

It is an object of safety brake devices to stop a conveying means that travels at an excessive speed. They must be able to stop the conveying means loaded with the rated load out of free fall, wherein a range is fixed for the delay to be achieved. Most of the known safety brake devices have brake shoes which are applied at a rail oriented in the conveying direction, for example a guide rail for an elevator cabin. In the known safety brake devices, the brake shoes are moved by eccentrics, wedges or rockers.

EP 1283189 A1 describes a device with a support element to be affixed at the conveying means and at least one brake shoe affixed thereto so as to be movable, which is intended to be applied at a rail arranged in a stationary manner parallel to the conveying route when the safety brake device is triggered. To that end, the brake shoe is movable at least approximately at a right angle to the conveying route. Further, an engagement lever is provided, which is arranged on the side of the rail opposite the brake shoe and is pivotable about a first axis oriented transversely to the rail between a release position and at least one brake position, wherein the rail, in the brake position, is clamped between the end of the engagement lever and the brake shoe. A trigger lever, which is pivotable about a second axis oriented transversely to the rail between a release position and at least one brake position, is coupled to the engagement lever such that, in each brake position of the trigger lever, also the engagement lever is in a brake position. This safety brake device has a simpler structure and smaller dimensions than known safety brake devices with a comparable braking effect.

The safety brake device of EP 1733992 A1 consists of a brake unit and a trigger unit. The brake unit consists of a first brake shoe and of a triangular, rotatable support with other brake shoes. A trigger arm, which is applied at the rotatable support and brings it in brake position, is held in release position until triggering takes place by means of a mechanical bolt. For the triggering of the device, the mechanical bolt can be released by means of an electromagnetic actuator actively controlled to that end, whereupon the trigger arm is pushed to the guide rail by a coaxial compression spring, a frictional connection with the guide rail is created there and the trigger arm is twisted due to the frictional connection, whereby also the support is twisted to the brake position. The rotational movement and the retreating of the brake shoes at the support result in the first brake shoe being guided to the guide rail and creating the required brake force.

EP 1439144 A2 discloses a safety brake device for an elevator system, having a catching device connected to the elevator cabin, which converts a relative movement of an actuating element extending along the guide rail for the elevator cabin to a braking force acting between catching device and guide rail, which braking force causes the vehicle to brake. The braking operation is activated via a speed limiter. The braking device further comprises an electromechanical trigger device, which is equipped with a brake acting electromechanically upon the guide rail and which is movable relative to the elevator cabin on the guide rail. The trigger device is coupled to the catching device by means of the actuation element such that a relative movement between vehicle and trigger device is converted to a relative movement of the actuation element and to a braking application of the catching device at the guide rail.

As disclosed in EP 3153451 A1, a trigger device for such a safety brake device can comprise, for example, a pivotably mounted trigger lever which is connectable to the safety brake device and is intended to be applied at a rail arranged in a stationary manner parallel to a conveying route, wherein the trigger lever is also displaceably mounted and loaded with a clamping force acting in a displacement direction. In a release position, the trigger lever is held in this release position by a hydraulically created retaining force counteracting the clamping force, wherein the trigger lever is movable from the release position to a clamping position by deactivation of the retaining force, in which clamping position the safety brake device is actuated during further relative movement of trigger device and guide rail. A fluidic actuator is provided, which acts upon the trigger element against the pretension force via a controllable source for the working fluid.

DE 202022100179 U1 discloses a safety brake device for an elevator cabin having a support element affixed at the elevator cabin and comprising a brake arrangement for a clamping engagement with the guide rail for the elevator cabin. Also here, a trigger arrangement having a trigger element that is displaceable parallel to the braking direction is provided, which trigger arrangement is connected, in terms of control engineering, to the brake arrangement in order to bring same to the brake position. The trigger arrangement has a clamping roller, which is displaceable from a release position to a brake position resting against the guide rail and, during further relative movement of elevator cabin and guide rail, rolls further, essentially parallel to the braking direction, to a second brake position. Here, a force in a direction towards the brake position of the trigger element acts upon the trigger element. An electrically controllable actuation arrangement prevents and/or causes the movement of the contact roller in the first brake position, i.e. for contact with the guide rail. The trigger arrangement comprises a trigger clamping surface oriented parallel to the braking direction and towards the guide rail, which trigger clamping surface moves together with a clamping roller transversely to the direction of movement of the elevator in a direction of the guide rail. This trigger clamping surface is adjoined, on both sides and viewed in both directions of movement, by main clamping surfaces, which are anchored on the trigger base body separately from the trigger clamping surface, and are not moved with the clamping roller. These main clamping surfaces are spring-mounted and located essentially also parallel to the guide rail and to the trigger clamping surface. The trigger clamping surface and the main clamping surfaces are arranged and designed such that the clamping roller rolls beyond each end of the trigger clamping surface into the gap between a main clamping surface and the guide rail, irrespective of whether an upwards or a downwards movement is currently executed. The trigger clamping surface is mounted at one end of the lever, upon whose other end acts an electrically activatable actuation arrangement having a controllable electromagnet, which holds the clamping roller in the release position against the pretension force.

WO 2013/079288 A1 discloses an elevator system with an elevator cabin displaceable along guide rails and a braking system with preferably two safety brakes. The safety means is controlled via control means, which can trigger the safety means in critical or uncritical events. The control means further include a function for an automatic resetting of the safety brake when an event that is assessed as uncritical is specified as reason for the triggering of the safety brake. The resetting steps can also be initiated manually.

If the still elevator system is to be shut down, or has been shut down, over a longer period of time, the holding circuit of the holding magnet of the braking device can be interrupted, just like in an emergency. This releases the holding means and the safety brake is moved to the braking position in the same manner as in an emergency. When the energy supply of the elevator system is switched back on in this case, the elevator controller starts an automatic reset after a positive run through various tests and initializations. Otherwise, a further operation of the elevator system remains interrupted until a manual reset takes place.

### SUMMARY OF THE INVENTION

It was an object of the present invention to specify a device by means of which safety brake devices can be triggered, preferably electrically, with the highest reliability.

This object is achieved by means of a device in accordance with one aspect of the invention.

These known devices must be supplied with current in a neutral state in order to maintain the trigger element in its passive position. As this current consumption is to cease during longer or intentional interruptions of the operation of the conveying means, the current is interrupted here, which leads to an abrupt and hard transition to the active position with the trigger element stopping at the end position. This results in a loud noise, and, in case of frequent execution, there is also the risk of damage to the plant.

It is therefore another object of the present invention to improve devices mentioned in the beginning in order to reduce the noise emission upon deactivation of the safety brake device and ensure a soft, material-protecting deactivation.

This other object is achieved by means of a device in accordance with another aspect of the invention.

Starting point of the invention is a safety brake device for a conveying means, in particular for an elevator cabin and/or for a counterweight, having a support element to be affixed at the conveying means at least with the brake arrangement and with a free space, which, in an installed state of the safety brake device, receives a rail arranged in a stationary manner parallel to the conveying route, wherein the brake arrangement is designed to clamp the rail located in the free space in the brake position. Further, a trigger arrangement is provided which is connected, in terms of control engineering, to the brake arrangement in order to bring same to a brake position.

The safety brake device in accordance with the invention comprises a trigger element, which can be placed optionally between a trigger position, in which it protrudes into the free space, and a passive position outside the free space, wherein the trigger element, at least in its trigger position, is movable, relative to the brake arrangement and relative to the free space, to a brake position, and an electrically controllable actuation arrangement causes the position change of the trigger element between passive position and trigger position. This permits, in a simple manner, a basis for the evaluation of a switching operation of the safety brake device from a passive, basic state to the triggered, active state, which switching operation is electrically controlled by acceleration, velocity or weight sensors.

Preferred here is an embodiment in which the trigger element is displaceable, in a manner controlled by the actuation arrangement, along or parallel to the longitudinal axis of the trigger element between the passive position and the trigger position.

An advantageous advancement of this device is a safety brake device with at least one brake shoe affixed at the support element, having a braking surface, which extends in braking direction and is intended to be applied at the rail passing the free space when the safety brake device is triggered, wherein the brake shoe is movable at least approximately at a right angle to the braking surface. Here, the braking direction is the direction along which the brake shoe moves along the rail received in the free space during the braking operation. Here, the braking direction is typically perpendicular to the braking surface and is identical to the course of the rail received in the free space. This device further comprises at least one engagement element, which is arranged on the side of the free space opposite the brake shoe and is placeable between a release position and at least one brake position, wherein the engagement element and the brake shoe are at their shortest distance in the brake position. This embodiment is characterized in that the trigger element is pivotable to at least one brake position and is coupled to the engagement element such that, in each brake position of the trigger element, also the engagement element is in a brake position. This device is further characterized in that the trigger element is designed such that, in its trigger position, it is pivotable to a brake position when the support element moves in a braking direction.

Preferably, the trigger element has a contact element, or is connected to a contact element, at its section protruding into the free space in the trigger state, which contact element is designed to be applied at the rail. This enables the trigger element to be optimally designed for the contact with the rail.

Another embodiment in accordance with the invention is characterized in that the trigger element is acted upon with a pretension force in a direction towards the trigger position by means of an actuator, wherein the actuation arrangement, in an activated state, counteracts the pretension force and holds the trigger element in the passive position. The mode of operation of the electric triggering enables the trigger unit to be used both for double-acting and for single-acting safety brake devices. During a power cut, the safety brake device is activated in any case due to the discontinuation of the retaining effect of the electrical actuation arrangement, so that the highest reliability is provided.

An advantageous embodiment provides in this context that the actuation arrangement has a controllable electromagnet, which acts upon the trigger element against the pretension force when supplied with current.

Alternatively, the actuation arrangement of a safety brake device in accordance with the invention could have at least one fluidic actuator, which acts upon the trigger element against the pretension force via a controllable source for the working fluid.

Another possible embodiment of a safety brake device is characterized in that, when supplied with current by means of a fluidic, electric or electromagnetic actuator, the actuation arrangement acts upon the trigger lever with a force in a direction towards the trigger position, in which the section of the trigger element facing the rail is applied at the rail.

The safety brake device in accordance with the invention in a structurally simple and functionally reliable embodiment is characterized in that the trigger element is applied immediately at the engagement element.

An embodiment with less need for space transversely to the rail provides a trigger lever which is offset relative to the engagement element in braking direction and a connection element running in braking direction, which connects the trigger lever to the engagement lever.

An embodiment modified from this, which offers increased mechanical strength for higher loads, is characterized in that a connection element running in braking direction connects the trigger lever to an auxiliary trigger lever, which is affixed at the support element and pivotable between a release position and at least one brake position, wherein the auxiliary trigger lever is coupled to the engagement element such that, in each brake position of the auxiliary trigger lever, also the engagement element is in a brake position. Preferably, the pivot axis of the auxiliary trigger lever is oriented transversely to the braking direction.

To achieve the other object, the device is characterized by a controller for the actuation arrangement, which is designed to move the trigger element to the trigger position upon manual input or in accordance with a specifiable schedule while the actuation arrangement is active and to then deactivate the power supply of the actuation arrangement, and to subsequently reactivate the power supply of the actuation arrangement until a new manual input takes place, or in accordance with the specifiable schedule, and to move the trigger element to the passive position again.

Here, the actuation arrangement preferably has a controllable electromagnet, which acts upon the trigger element against the pretension force when supplied with current. This ensures a good holding force with simple control and triggering.

In order to ensure a particularly quiet switching to the deactivated state that protects the material of the device by means of gentle motion sequences, the controller for the actuation arrangement is designed such that, in case of a manual input or in accordance with a specifiable schedule, the actuation arrangement is activated such that the trigger element is moved to the trigger position more slowly than in an emergency.

In accordance with a preferred embodiment of the invention, the actuation arrangement has an electric rotary motor, which acts upon the trigger element in order to move same between passive position and trigger position.

Particularly simple to control and operate is an embodiment in accordance with the invention in which the rotary motor is designed to move in one direction of rotation only.

In order to ensure a particularly quiet switching to the deactivated state that protects the material of the device by means of gentle motion sequences, the rotary motor is advantageously operated with lower rpm in case of a manual input or in accordance with a specifiable schedule than after an emergency.

### BRIEF DESCRIPTION OF THE DRAWINGS

For the purpose of better understanding of the invention, it will be elucidated in more detail by means of the figures below.

The figures show in a respectively very simplified schematic representation:

FIG. 1 a safety brake device in accordance with the invention in the initial position in a perspective view;

FIG. 2 the safety brake device of FIG. 1 in a triggered position in a side view;

FIG. 3 the safety brake device of FIG. 1 at the start of the braking operation during downward movement;

FIG. 4 the safety brake device of FIG. 1 in the end position for the braking operation during downward movement;

FIG. 5 the safety brake device of FIG. 1 at the start of the braking operation during upward movement;

FIG. 6 the safety brake device of FIG. 1 in the end position for the braking operation during upward movement.

FIG. 7 a schematic circuit diagram for the control of the safety brake devices of FIGS. 1 to 6.

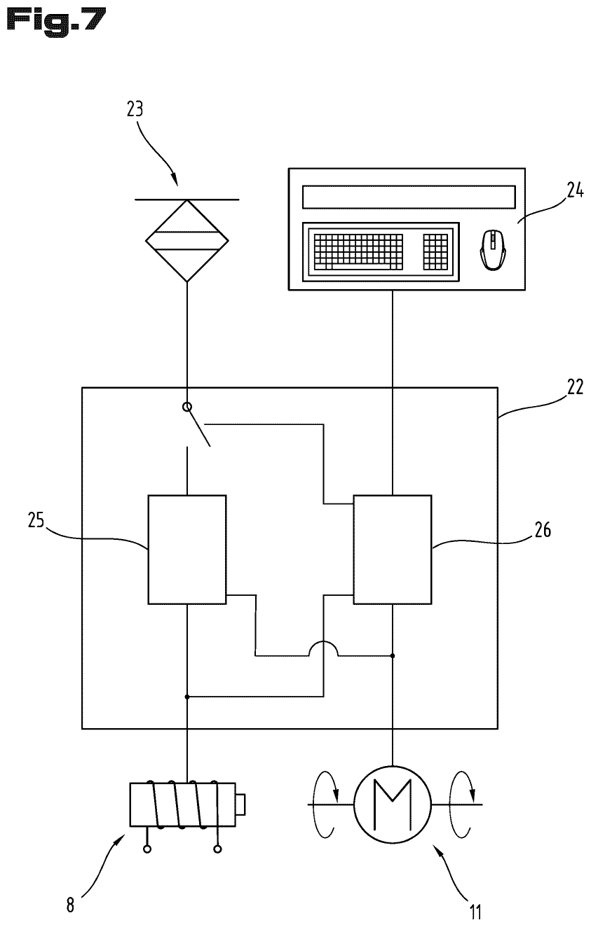

### DETAILED DESCRIPTION OF PREFERRED EMBODIMENTS

First of all, it is to be noted that, in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure, and in case of a change of position, these specifications of location are to be analogously transferred to the new position.

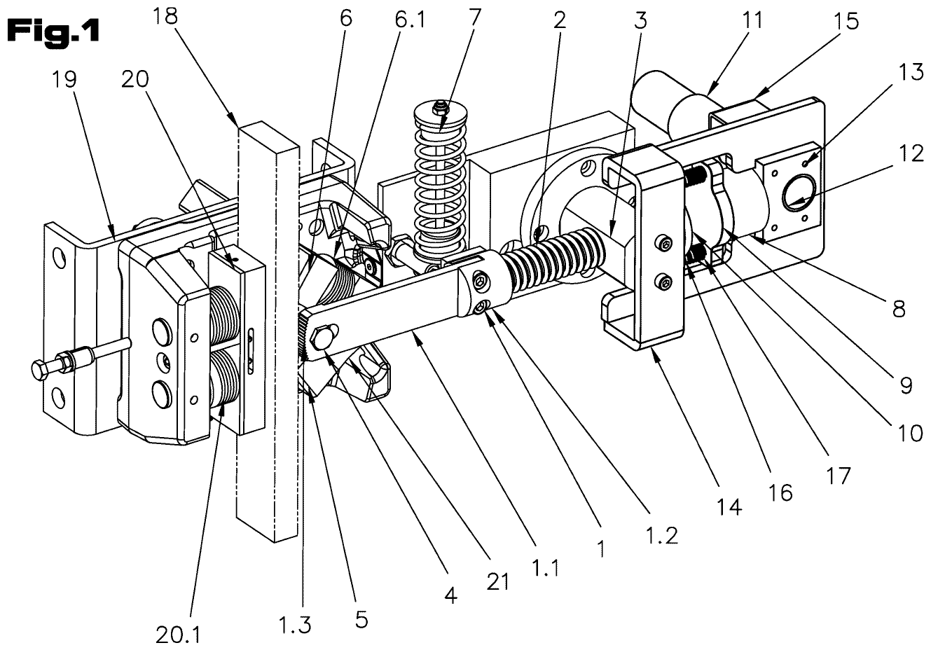

FIG. 1 shows an embodiment of a safety brake device in accordance with the invention for a conveying means. It is in particular intended for an elevator cabin or also for its counterweight, which is connected to the elevator cabin via ropes, belts or suchlike. Within the scope of the present description and claims and due to their close functional connection, both elements are summarized under the term conveying means.

The exemplary embodiment of a safety brake device explained in more detail in the description below and represented in the drawing figures is equipped with electric triggering by an electrically actuated holding magnet 8. In a preferred manner, the trigger element 1 is configured as a trigger lever.

Here, a support element 19 of the safety brake device, at which support element 19 at least one brake shoe 20 is attached, is affixable to the conveying means. After the brake device is triggered, the brake shoe 20 is finally applied at a rail 18 of the conveying means to achieve the braking effect, which rail 18 extends parallel to the route of the conveying means when the conveying means and the support element 19 move further relative and parallel to the rail 18. The brake shoe 20 preferably comprises a braking surface, which extends in braking direction. The braking direction runs essentially parallel to the rail 18, so that the braking surface is also oriented essentially parallel to the rail 18. The direction of motion of the brake shoe 20, however, is typically located transversely to the braking direction and to the extension of the rail 18. This rail 18 can be formed by a part of the arrangement for operating the conveying means that is provided anyway, for example a guide, for example of an elevator cabin. If such a guide or similar element is not suitable to interact with the safety brake device in accordance with the invention, a rail 18 designed thereto can be installed independently and be integrated in the system also in addition to the conveying means being equipped with the safety brake device, but it is nevertheless not a part of the safety brake device in accordance with the invention. Within the scope of the invention, the term “rail” is understood to mean all such elements at which the safety brake device in accordance with the invention can be applied.

Here, the brake shoe 20, which is preferably supported via disc springs 20.1 and preferably also displaceable parallel to the rail 18 by a small distance, is movable at least approximately transversely to the braking surface and thus also to the conveying route and to the rail 18. The movement of the brake shoe 20 towards the rail 18 is caused by an engagement element 21 affixed at the support element 19, which engagement element 21 is arranged at a distance on the side opposite the braking surface of the brake shoe 20, with the rail 18 passing between the brake shoe 20 and the engagement element 16. Here, the engagement element 21 is pivotable between a release position and at least one brake position as the furthest deflected end position.

Between the brake shoe 20 and the engagement element 21, a free space is defined, which, in the installed state of the safety brake device, receives the rail 18 arranged in a stationary manner parallel to the conveying route. In the passive position of the safety brake device, the rail 18 can be guided through the free space unimpeded. In the braking state, at least the elements of the brake arrangement having a braking effect protrude so far into this free space that the rail 18 is clamped and fixed between these elements, in particular between the brake shoe 20 and the engagement element 21.

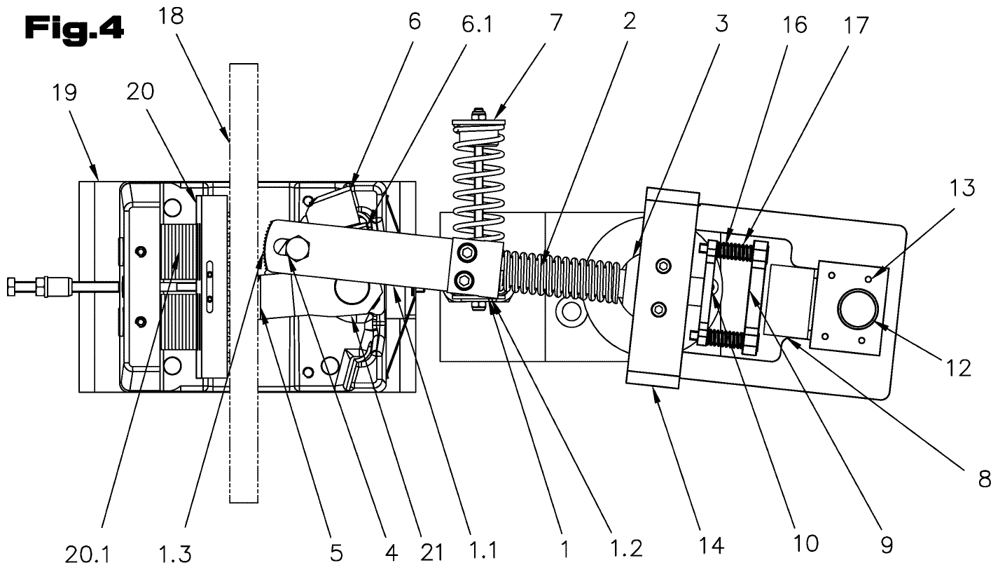

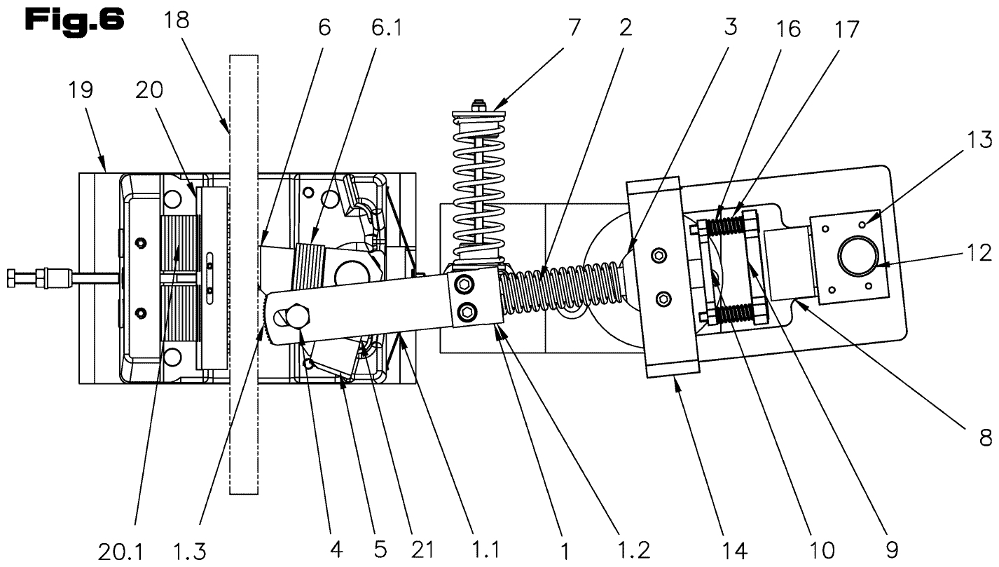

Preferably, the engagement element 21 is configured as an engagement lever and typically fork-shaped or V-shaped and with two heads 5 and 6 and pivotable between a release position (FIG. 1) and at least one brake position (FIG. 4 and FIG. 6) as the furthest deflected end position. The heads 5, 6 are designed to protrude respectively into the free space after a first, slight pivoting of the engagement element 21 in any direction, finally be applied at the rail 18 and, due to the friction at the rail 18, pivot the engagement lever 21 completely to the furthest deflected brake position about a first axis preferably oriented transversely to the braking surface and/or to the rail 18. In this respective brake position, the rail 18 is clamped between the respective end of the engagement element 21 and the brake shoe 20, and the conveying means equipped with the support element 19 is braked and fixed in a stationary manner in relation to the rail 18. Of course, also embodiments with two separate engagement levers 21 are possible in order to have one independent lever each for both directions of motion of the conveying means along the rail 18. Also, at least one of the heads of at least one engagement lever, preferably the head 6 effective for the upward catch, for example of the V-shaped engagement element 21, can be supported at the lever body via disc springs 6.1. The engagement element 21 could also be formed as an eccentric arrangement, as a cam adjustable about an axis transversely to the rail 18 or similar arrangements, which, in the course of their twisting or pivoting, cause a change in the distance of their axis to the rail 18.

The first slight deflection of the engagement element 21 is caused by a trigger element 1 attached at the support element 19 so as to be movable. Preferably, this trigger element 1 is configured as a trigger lever 1 affixed so as to be pivotable, which is pivotable about a second axis oriented transversely to the rail 18 and/or transversely to the braking surface of the brake shoe 20 between a release position and at least one brake position. The trigger element 1, preferably in the form of the trigger lever, is coupled to the engagement element 21, for example via the lever screw 4, which is done in the embodiment of the safety brake device in accordance with the invention represented in the drawing figures by the section of the trigger lever 1 facing the rail 18 being applied directly at an axis of rotation at the engagement lever 21. Each pivoting of the trigger lever 1 to any brake position, which pivoting is caused by the frictional connection of the head 1.3 of the trigger lever 1 resting against the rail 18 after the safety brake device is triggered, is thus transferred to the engagement lever 21, which then also reaches one of its brake positions. The trigger element 1 can be connected, for example in the region of the head 1.3 of a trigger lever, to a contact element or comprise such an element, which, in a brake position, protrudes into the region that is located between the braking surface of the brake shoe 20 and the engagement element 21.

Other than this direct connection of trigger lever 1 and engagement lever 21, in which these are arranged in alignment with and/or parallel to each other, wherein the trigger element 1 must be substantially longer than the engagement element 21, also an alternative embodiment with less need for space transversely to the rail 18 is conceivable. Here, the trigger element 1 is offset relative to the engagement lever 21 in a longitudinal direction of the rail 18, and the pivoting of the trigger lever 1 is transferred to the engagement lever 21 via a connection element running parallel to the rail 18.

An embodiment even further modified that has a trigger lever 1 offset relative to the engagement element 21 in a longitudinal direction of the rail 18 provides the transfer of the pivoting of this trigger lever 1, resting against the rail 18 with a frictional connection, via the connection element running parallel to the rail to an auxiliary trigger lever also affixed at the support element 19 so as to be pivotable. This auxiliary trigger lever is pivotable, in a manner controlled by the trigger lever 1, about a third axis oriented transversely to the rail between a release position and at least one brake position and passes on this movement, via its coupling, to the engagement lever 21. Without the auxiliary trigger lever itself, which is now positioned parallel to and/or in alignment with the engagement lever 21, having to come into contact with the rail 18, the pivoting of the trigger lever 1 to a brake position is passed on reliably to the auxiliary trigger lever and from same further to the engagement lever, which is then also in a brake position.

In accordance with the invention, the trigger element 1 in each of the embodiments explained above is mounted so as to be displaceable along or parallel to its longitudinal axis in a rotatably mounted receiving element 3. The receiving element 3 enables the rotational movement required to move the trigger lever 1, and thus the engagement lever 21, from the basic position represented in FIG. 1 to the respective brake position. The positioning spring 7, which is applied at the trigger lever 1 via a shaft 1.2 positioned between the head 1.3 of the trigger lever 1 and the receiving element 3, counteracts each deflection of the trigger lever 1 from the position represented in FIG. 1 and ensures thus that the trigger element 1 cannot move upward or downward independently and inadvertently.

Between the section 1.1 of the trigger lever 1 located closer to the rail 18 and/or to the free space and the receiving element 3, an actuator is clamped, which acts upon the trigger lever 1 with a pretension force in a direction towards the rail 18. A compression spring, for example, can be provided as actuator 2 and preferably be wound around a rod-shaped center section of the trigger lever 1 in order to press the trigger lever 1 against the rail 18 to activate the safety brake device. In a functionally homogeneous manner, this could be caused by means of any fluidic, electric or electromagnetic actuators, which, upon activation by corresponding application of current, act upon the trigger lever with a force towards the end position, in which the end 1.3 of the trigger lever 1 protruding into the free space and/or facing the rail 18 is in contact with the rail 18 and thus produces a frictional connection. Preferably, the end of the trigger element 1 facing the rail 18 is equipped with a structure improving the frictional connection, for example equipped with a sharp-edged toothing as represented, in order to ensure a reliable deflection of the trigger lever 1 after contact with the rail 18 and during further relative movement of conveying means to support element 19 and rail 18. Instead of a sharp-edged toothing, also other solutions are conceivable, for example coatings or layers from materials with a high coefficient of friction.

In the basic position of the safety brake device of FIG. 1, with a non-deflected trigger lever 1 and a non-deflected engagement lever 21, the head 1.3 of the trigger lever 1 is held against the pretension force of the compression spring 2 or of any other actuator at such a distance to the rail 18 that an inadvertent braking of the conveying means is reliably prevented. To that end, there is a gap dimension between 1 and 10 mm, preferably between 2 and 4 mm, particularly preferably of 3 mm, between rail 18 and head 1.3 of the trigger lever 1.

In accordance with the invention, this retention effect on the trigger lever 1 is caused by an electrically controllable actuation arrangement and/or the displacement of the trigger lever to the end position with contact with the rail 18 is caused by such an actuation arrangement. In the embodiment represented in the drawing figures, an electronically controllable electromagnet 8, in particular a clamping magnet, is used to that end.

In the basic position of FIG. 1 of the safety brake device, the electromagnet 8 is supplied with current, whereby a magnet receiving plate 9 is held in the position closest to the electromagnet 8, preferably resting against it, by the magnetic force. The magnet receiving plate 9 is connected, via connection elements, to a connection plate 10 spaced apart and affixed or shaped as one piece at the rear end of the trigger lever 1 remote from the rail 18. Preferably, the connection elements are adjustable lengthwise in order to be able to set the precise position of the trigger lever 1 between the electromagnet 8 and the rail 18. A preferred example of connection elements is an arrangement of mounting shoulder screws 16 and compression springs 17 clamped between connection plate 10 and magnet receiving plate 9.

Preferably, the electromagnet 8 is coupled to an eccentric 12, which is located in the eccentric housing 13 so as to be protected and can be actuated by a rotary motor 11. This arrangement ensures that the electromagnet 8 can be moved in alignment with or parallel to the lengthwise adjustment of the trigger lever 1. This arrangement permits a simple automatic resetting of the trigger lever 1 in that the electromagnet 8 is guided towards the trigger lever 1 by a rotary motor 11 and by the eccentric 12. The electromagnet 8 is resupplied with current, and therefore active, at the front position of the electromagnet 8 at the latest, so that it docks at the magnet receiving plate 9 and, when the movement of the rotary motor 11 is continued, carries along the arrangement of trigger lever 1, connection plate 10 and magnet receiving plate 9 to the neutral basic position remote from the rail 18 again. The arrangement of mounting shoulder screws 16 and compression springs 17 between magnet receiving plate 9 and connection plate 10 enables an approach of the two plates 9, 10, should the electromagnet 8 be guided too far in a direction of the trigger lever 1 and collide with the arrangement of trigger lever 1 and the two plates 9, 10 still abutting on the rail 18.

The arrangement of electromagnet 8 and eccentric housing 13 is affixed at the rotatably mounted receiving element 3 via a receiving metal sheet 14, in particular via a front, cage-like section. This receiving metal sheet 14 is connected to holder 15 for the rotary motor or forms same as one piece.

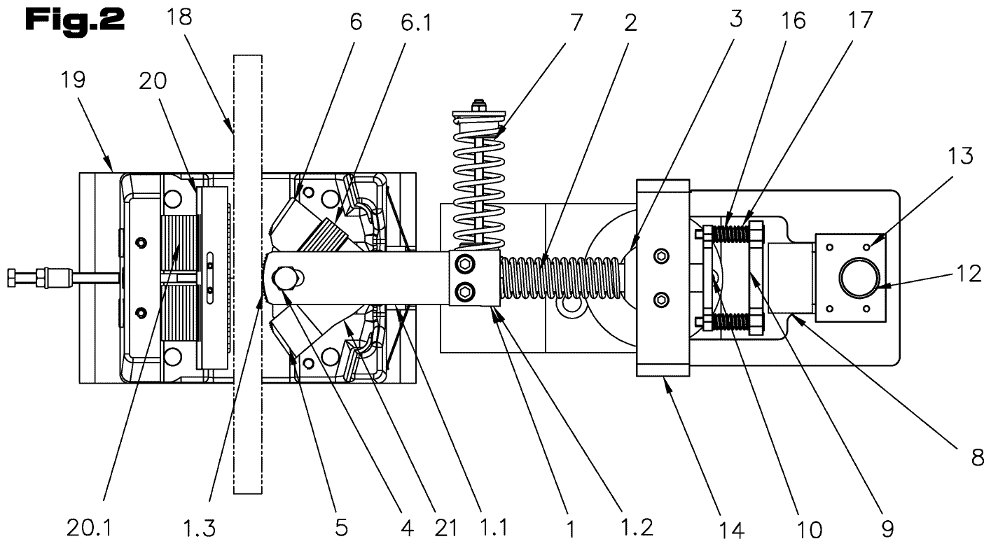

FIG. 2 shows the trigger unit in an actuated state at the start of the brake catching operation. To actuate the safety brake device, the application of current to the electromagnet 8 is interrupted, whereby the entire trigger lever 1 is moved, together with the magnet receiving plate 9 and connection plate 10, in a direction of the rail 18 by the compression spring 2 and/or the trigger element 1 protrudes with its front section into the free space. After the original distance between rail 18 and trigger lever 1 has been bridged, a frictional connection between trigger lever 1 and rail 18 forms between the head 1.3 of the trigger lever 1, preferably optimized by the sharp-edged toothing. During further relative movement between the conveying means, which carries the entire arrangement described above or is connected thereto, in a braking direction relative to the rail, the trigger element 1 then moves against the effect of the positioning spring 7 in the direction opposite the movement of the conveying means and thus makes the safety brake device retreat.

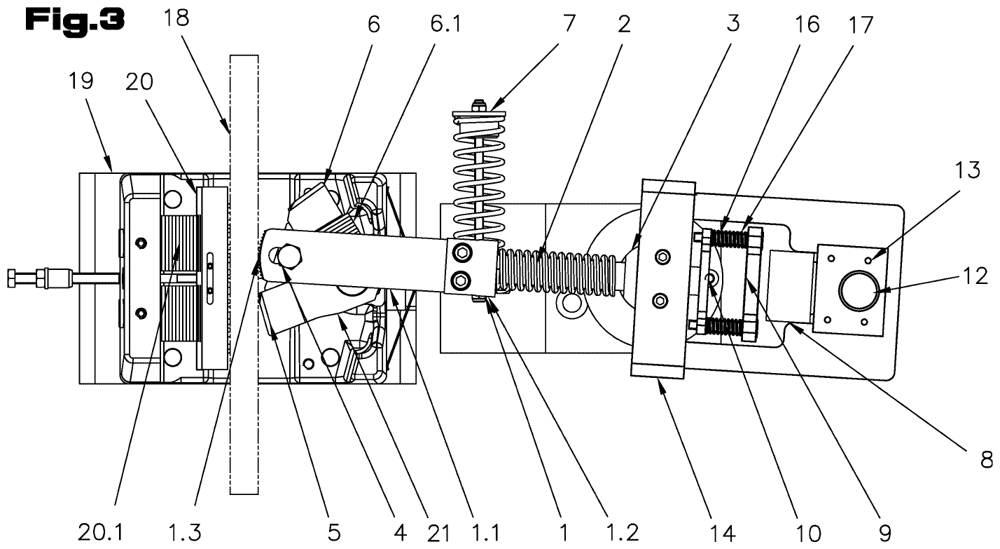

FIG. 3 shows the safety brake device in accordance with the invention in the process of the downward catch. The position represented shows the moment in which the lower head 5 of the engagement element 21 engages with the rail 18. Here, it can clearly be seen that, in this state, the head 1.3 of the trigger lever 1 remains at the rail 18, preferably with the sharp-edged toothing, and the compression spring 2 keeps pressing the trigger lever 1 against the rail 18. The positioning spring 7 moves along with the trigger lever 1, wherein the positioning spring 7 is guided with a pin in the shaft 1.2. As the trigger element 1 is guided in the receiving element 3, the receiving element 3 participates in the entire pivoting movement, as do the receiving metal sheet 14, the electromagnet 8, the eccentric 12, the eccentric housing 13, the rotary motor 11 and its rotary motor holder 15, which are firmly connected to the receiving element 3.

FIG. 4 shows the safety brake device and trigger unit in the end position for the downward catch. At this point in time, the trigger element 1 has no contact to the rail. This ensures that it cannot be damaged during the actual braking operation. This change in the distance is enabled by guiding the front section 1.1 of the trigger lever 1 with an oblong hole or an open-fronted slot at the lever screw 4. As a result of the pivoting of the engagement element 21 to the braking end position, the trigger element 1 is simultaneously pushed away from the rail 18 in its longitudinal direction or parallel thereto, if necessary also against the effect of the compression spring 2.

The magnet receiving plate 9 is in the position most remote from the electromagnet 8. In this position, the rotary motor 11 is switched on, which rotary motor 11, in the course of its movement, then guides the electromagnet 8 towards the magnet receiving plate 9 by means of the eccentric 12. During this operation, the electromagnet 8 is resupplied with current in order to activate the magnetic force and cause the magnetic coupling to the magnet receiving plate 9. The arrangements of spring 17 and the mounting shoulder screw 16 ensure that no component, in particular not the rotary motor 11, is damaged, even if the electromagnet 8 is moved even further towards the magnet receiving plate by the rotary motor 11 after reaching the position of the magnet receiving plate 9. When the rotary motor 11 is actuated further, the trigger lever 1 coupled via the magnetic force is retracted to the basic position and the compression spring 2 is tensioned again. The rotary motor 11 performs a complete revolution for the entire resetting process.

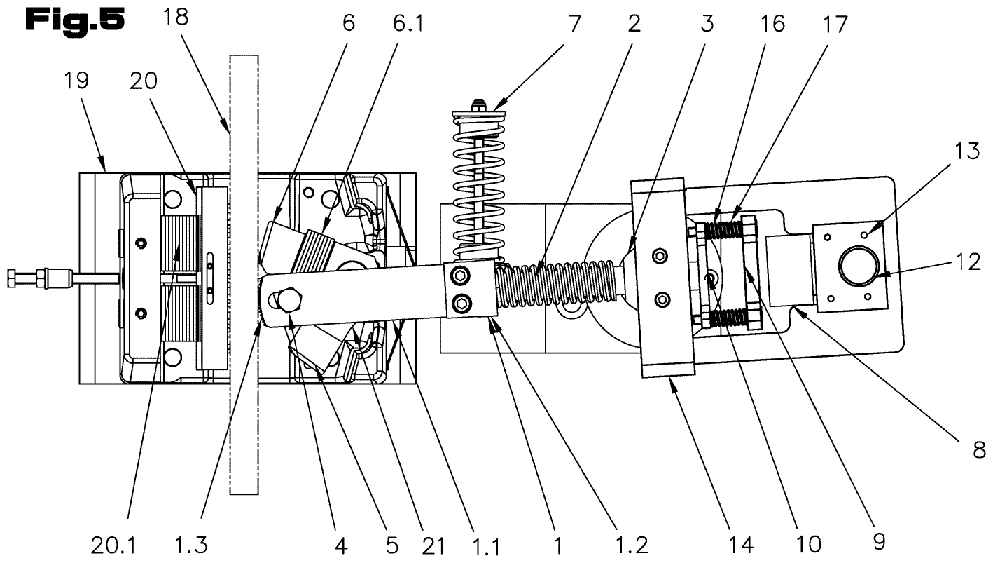

FIG. 5 shows a state of the safety brake device corresponding to FIG. 3, this time, however, for the upward catch. Also here, the head 1.3 of the trigger lever 1 is still positioned, preferably with a toothing, at the rail 18, even though the upper head 6 of the engagement element 21 is already engaging with the rail 18. The positioning spring 7 moves along with the trigger lever 1 also in this direction.

FIG. 6 shows the safety brake device and trigger unit in the end position for the upward catch. This state corresponds to that of FIG. 4, with the levers 1 and 21 respectively being deflected in the opposite directions, like in FIG. 4. Also during the upward catch, the head 1.3 of the trigger lever 1 is no longer in contact with the rail 18. The resetting is done analogously to what has been explained in relation to FIG. 4.

All operations in an emergency explained above are clearly carried out as quickly as possible, with the highest possible speed of movement of the individual components and with corresponding noise emission. Starting from the basic position with the electromagnet 8 still supplied with current in the normal operation of the conveying means and thus the actuation arrangement still held in the release position, in which also the trigger element 1 remains in the release position, the safety brake device is triggered, in the event of an incident, for example by a sensor arrangement 23 for the monitoring of the speed and/or the monitoring of the acceleration and/or the monitoring of the weight. Here, the application of current to the electromagnet 8 is stopped, so that the trigger lever 1, is moved in a direction towards the rail 18 under the action of the compression spring 2 until it finally rests against the rail 18 and enters into a frictional connection thereto. This results in the safety brake device being in the activation position. If the safety brake device is to be deactivated for reasons of energy efficiency, for example in case of a longer standstill of the conveying means and the entire plant, wherein the electromagnet 8 is switched current-free, it is desired for protection of the material and for a lower noise emission to carry out the deactivation in a gentle and quiet manner.

To that end and in accordance with the invention, it is provided that the safety brake device is equipped with a controller 22 for the actuation arrangement 8, 11, 22, which switches off the plant upon manual input by a user or in accordance with a specifiable schedule which is deposited in or feedable to the controller 22, moves the trigger element 1 to the trigger position while the actuation arrangement is still active and yet prevents it from springing forward to this trigger position by the force of the compression spring 2. In this trigger position, the trigger element 1 is fixed so as to be in contact with the rail 18 and resting against it, typically by the effect of the compression spring 2. In this position, the power supply of the actuation arrangement 8, 11, 22 is deactivated via the controller 22. In particular, the respective electromagnet 8 is deactivated by this current interruption, without the element that was initially held back by this being able to move further. A pushbutton, a lever, a keyboard and/or mouse 24 or similar can be connected to the controller 22 as actuating elements for deactivating the safety brake device. The sensor system can alternatively also be integrated into the controller 22 or formed by the controller 50 itself. In order to ensure a particularly quiet switching to the deactivated state, the controller 22 for the actuation arrangement is designed such that, in case of a manual input or in accordance with a specifiable schedule, the trigger element 1 is moved to the trigger position more slowly than in an emergency. To that end, the electric rotary motor 11, which acts upon the trigger element 1 in order to move it from the trigger position back to the passive position again after an emergency, is activated preferably already in the passive position and while the electromagnet 8 is still active. Preferably, the rotary motor 11 is also operated more slowly, i.e. with lower rpm, than during the return of the trigger element 1 after an emergency. Particularly simple to control and operate is an embodiment in accordance with the invention in which the rotary motor 11 is designed to move in one direction of rotation only.

For a resumption of operation of the conveying means with the safety brake device in accordance with the invention, the deactivation must either be reactivated via the operating elements 24 or the power supply of the actuation arrangement must be reactivated in accordance with the specifiable schedule, and the trigger element 1 is moved back to the passive position during this process by means of the electric motor 11 and when the electromagnet is resupplied with current. Here, like after an emergency, the trigger element 1 is moved back again against the effect of the compression spring 2.

The controller explained above can also be used independently for other safety brake devices than those of the present application and for brakes of elevators, lifting means, or suchlike.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

### Table of Reference Numbers

1 trigger lever
1.1 front section
1.2 shaft
1.3 head of the trigger lever
2 compression spring
3 receiving element
4 lever screw
5 head of the engagement lever
6 head of the engagement lever
7 positioning spring
8 electromagnet
9 magnet receiving plate
10 connection plate
11 rotary motor
12 eccentric
13 eccentric housing
14 receiving metal sheet
15 rotary motor holder
16 mounting shoulder screw
17 compression spring
18 rail
19 support element
20 brake shoe
20.1 disc springs
21 engagement lever
22 control
23 sensor
24 operating element
25 normal operation software module
26 deactivation software module

1-17. (canceled)

18. A safety brake device for a conveying means, in particular for an elevator cabin and/or for a counterweight having a support element (19) to be affixed at the conveying means at least with a brake arrangement (20, 21) and with a free space, which, in an installed state of the safety brake device, receives a rail (18) arranged in a stationary manner parallel to the conveying route, wherein the brake arrangement (20, 21) is designed to clamp the rail (18) located in the free space in the brake position; and with a trigger arrangement, which is connected, in terms of control engineering, to the brake arrangement in order to bring same to the brake position, wherein the trigger arrangement comprises a trigger element (1), which can be placed optionally along or parallel to its longitudinal axis between a trigger position, in which it protrudes into the free space, and a passive position outside the free space, wherein the trigger element (1), at least in its trigger position, is movable, relative to the brake arrangement (20, 21) and relative to the free space, to a brake position and has a contact element, or is connected to a contact element, at its section protruding into the free space in the trigger state, which contact element is designed to be applied at the rail (18) and wherein an electrically controllable actuation arrangement (8, 11, 22) causes the position change of the trigger element (1) between passive position and trigger position, wherein the trigger element (1) is acted upon with a pretension force in a direction towards the trigger position by means of an actuator (2), and wherein the actuation arrangement (8, 11, 22), in an activated state, counteracts the pretension force and holds the trigger element (1) in the passive position.

19. The safety brake device according to claim 18, with at least one brake shoe (20) affixed at the support element (19), having a braking surface, which extends in braking direction and is intended to be applied at the rail (18) passing the free space when the safety brake device is triggered, wherein the brake shoe (20) is movable at least approximately at a right angle to the braking surface; at least one engagement element (21), which is arranged on the side of the free space opposite the brake shoe and is placeable between a release position and at least one brake position, wherein the engagement element (21) and the brake shoe (20) are at their shortest distance in the brake position, wherein the trigger element (1) is pivotable to at least one brake position and is coupled to the engagement element (21) such that, in each brake position of the trigger element (1), also the engagement element (21) is in a brake position; wherein the trigger element (1) is designed such that, in its trigger position, it is pivotable to a brake position when the support element (19) moves in a braking direction, wherein the engagement element (21) is pivotable between a release position and at least one brake position as the furthest deflected end position about an axis preferably oriented transversely to the braking surface and/or to the rail (18).

20. The safety brake device according to claim 18, wherein the actuation arrangement (8, 11, 22) comprises a controllable electromagnet (8), which acts upon the trigger element (1) against the pretension force when supplied with current.

21. The safety brake device according to claim 18, wherein the actuation arrangement (8, 11, 22) has at least one fluidic actuator, which acts upon the trigger element (1) against the pretension force via a controllable source for the working fluid.

22. The brake catching arrangement according to claim 18, wherein, when supplied with current by means of a fluidic, electric or electromagnetic actuator, the actuation arrangement (8, 11, 22) acts upon the trigger element (1) with a force in a direction towards the trigger position.

23. The safety brake device according to claim 19, wherein the trigger element (1) is applied immediately at the engagement element (21).

24. The safety brake device according to claim 19, wherein the trigger element (1) is offset relative to the engagement element (21) in braking direction, and a connection element running in braking direction connects the trigger lever (1) to the engagement element (21).

25. The safety brake device according to claim 24, wherein a connection element running in braking direction connects the trigger lever (1) to an auxiliary trigger lever, which is affixed at the support element (19) and pivotable between a release position and at least one brake position, wherein the auxiliary trigger lever is coupled to the engagement lever (21) such that, in each brake position of the auxiliary trigger lever, also the engagement element (21) is in a brake position.

26. The safety brake device, according to claim 18, with
a) at least one brake arrangement (20, 21) connected to a conveying means;
b) a trigger arrangement, which is connected, in terms of control engineering, to the brake arrangement in order to bring same to a brake position;
c) at least one trigger element (1), which is integrated in the trigger arrangement and which can optionally be placed between a trigger position and a passive position,
d) an actuator (2), which acts upon the trigger element (1) with a pretension force in a direction towards the trigger position;
further comprising
e) an electrically controllable actuation arrangement (8, 11, 22) for changing the position of the trigger element (1) between passive position and trigger position, wherein the actuation arrangement, in an activated state, counteracts the pretension force and holds the trigger element (1) in the passive position, and
f) a controller (22) for the actuation arrangement (8, 11, 22), which is designed to move the trigger element (1) to the trigger position upon manual input or in accordance with a specifiable schedule while the actuation arrangement is active and to then deactivate the power supply of the actuation arrangement, and to subsequently reactivate the power supply of the actuation arrangement (8, 11, 22) until a new manual input takes place, or in accordance with the specifiable schedule, and to move the trigger element (1) to the passive position again.

27. The safety brake device according to claim 26, wherein the actuation arrangement (8, 11, 22) comprises a controllable electromagnet (8), which acts upon the trigger element (1) against the pretension force when supplied with current.

28. The brake catching arrangement according to claim 26, wherein the controller (22) for the actuation arrangement (8, 11, 22) is designed such that, in case of a manual input or in accordance with a specifiable schedule, the actuation arrangement is activated such that the trigger element (1) is moved to the trigger position more slowly than in an emergency.

29. The brake catching arrangement according to claim 26, wherein the actuation arrangement (8, 22, 33) has an electric rotary motor (11), which acts upon the trigger element (1) in order to move same between passive position and trigger position.

30. The brake catching arrangement according to claim 29, wherein the rotary motor (11) is designed to move in one direction of rotation only.

31. The safety brake device according to claim 29, wherein, in case of a manual input or in accordance with a specifiable schedule, the rotary motor (11) is operated with lower rpm than after an emergency.
